(19) United States
(12) Patent Application Publication
(10) Pub. No.: US 2008/0091643 A1
(43) Pub. Date: Apr. 17, 2008

(54) Audio Tagging, Browsing and Searching Stored Content Files

(75) Inventor: Dale Malik, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/550,198

(22) Filed: Oct. 17, 2006

(51) Int. Cl. G06F 17/30

(52) U.S. Cl. 707/2

(57) ABSTRACT

Browsing through a plurality of content files stored on a device includes playing an audio thumbnail associated with each file highlighted by a user. Each audio thumbnail is a meaningful portion of content of a respective content file. Each audio thumbnail is user selectable and configured to play and/or display a respective content file associated therewith via the device. A method of searching content files stored on a device includes receiving an audible search command at the device from a user, wherein the search command includes search criteria for identifying one or more content files stored on the device; displaying a list of files that satisfy the search command; and serving a content file in response to user selection thereof. A voice tag may be recorded for a selected content file (or for a group of content files) via the device and stored in association with the served content file.

### FIELD OF THE INVENTION

The present invention relates generally to searching content and, more particularly, to methods, apparatus, and computer program products for searching content.

### BACKGROUND OF THE INVENTION

As media devices continue to shrink in size, user interface displays for these devices are also shrinking, and, for some devices, have disappeared altogether. For example, the iPod® Nano device for playing audio files has a very small user interface display and the iPod® Shuffle™ device has no display at all. Searching for content stored on many of these devices conventionally involves “thumb searching” wherein a user, via a finger, scrolls through lists of the stored content. Unfortunately, thumb searching can be cumbersome, time consuming, and inefficient. It may also be difficult to go directly to a particular content item via thumb searching. Moreover, users may be engaged in other activities when utilizing these media devices. For example, a user may be driving a car, jogging, etc., and thumb searching can be difficult to perform concurrently with these other activities.

### SUMMARY OF THE INVENTION

Embodiments of the present invention provide methods, apparatus, and computer program products that facilitate audibly searching and navigating content files stored on a device. According to some embodiments of the present invention, a method of navigating through a plurality of content files stored on a device includes playing an audio thumbnail associated with each content file. Each audio thumbnail is a meaningful portion of content of a respective content file. In addition, each audio thumbnail is user selectable and configured to play and/or display a respective content file associated therewith via the device.

According to some embodiments of the present invention, when a plurality of content files are audio files, each audio thumbnail may include one or more musical notes, and/or one or more words from the lyrics, from a respective audio file. Alternatively, each audio thumbnail may include an audio description of a respective content file. For example, an audio thumbnail of an audio, video, text and/or image file may include an audio description (e.g., the title, etc.) of the respective content file.

According to other embodiments of the present invention, a method of searching content files stored on a device includes receiving an audible search command at the device from a user, wherein the search command includes search criteria for identifying one or more content files stored on the device; displaying a list of one or more content files that satisfy the search command; and serving a content file via the device in response to user selection (audibly or otherwise) thereof via the displayed list. When a selected content file is an audio file, serving the selected content file may include playing the audio file via the device. When a selected content file is a video file, serving the selected content file may include displaying the video file via the device. When a selected content file is a text file, serving the selected content file may include displaying the text file via the device. When a selected content file is an image file, serving the selected content file may include displaying the image file via the device.

According to other embodiments of the present invention, a voice tag may be recorded for a selected content file (or for a group of content files) via the device and stored in association with the served content file. A voice tag identifies a served content file and can be used for subsequent selection of the content file by the user. Thus, a user can quickly and easily locate previous search results. Voice tags may be created at any time. For example, according to some embodiments of the present invention, voice tags are created when a file is downloaded to a device (e.g., when a music file is downloaded from a remote site). In addition, voice tags may be substituted for audio thumbnails by a user.

According to other embodiments of the present invention, a voice tag may contain an audio command that directs the device to modify how a selected content file is served to the user via the device. For example, a voice tag may include an audible command that directs the device to play an audio file faster, slower, higher in octave, etc.

According to other embodiments of the present invention, an apparatus includes a plurality of content files stored therein; a user selectable audio thumbnail associated with each content file, wherein each audio thumbnail is a meaningful portion of content of a respective content file; and a processor that is configured to serve a content file to a user in response to user selection of a respective audio thumbnail. According to some embodiments of the present invention, audio thumbnails may facilitate scrolling through files, particularly for devices not having displays. For example, as a user scrolls through a list of audio files on a device, an audio thumbnail associated with each file may play.

According to other embodiments of the present invention, an apparatus includes a plurality of content files stored therein and a processor that is configured to receive an audible search command at the device from a user, wherein the search command includes search criteria for identifying one or more content files stored on the device. The processor is also configured to display a list of one or more content files that satisfy the search command, and serve a content file via the device in response to user selection thereof via the displayed list. According to some embodiments of the present invention, the processor may be configured to record and store a voice tag for the selected content file via the device, wherein the voice tag identifies the served content file and can be used for subsequent selection of the content file by the user.

Other methods, apparatus and/or computer program products according to embodiments of the invention will be or become apparent to one with skill in the art upon review of the following drawings and detailed description. It is intended that all such additional methods, apparatus, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIGS. 1-2 are flow charts that illustrate exemplary operations for audibly searching and navigating content files stored on a device, according to some embodiments of the present invention.

FIG. 3 illustrates a device that is configured to play audio files but that does not having a visual display, and that is configured to play audio thumbnails as a user scrolls through audio files stored on the device.

FIG. 4 illustrates a user interface for creating voice tags, according to some embodiments of the present invention.

FIG. 5 is a block diagram that illustrates a processor and a memory hosted by a device that may be used in embodiments of an apparatus that includes a plurality of content files stored therein and that allows a user to audibly search and navigate these files, according to some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the terms “device” and “apparatus” have the same meaning and are interchangeable.

The present invention may be embodied as methods, apparatus, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “content file” means any type of audio file, video file, audio/video file, text file, gaming file, etc., that can be delivered and/or performed/displayed via a device. For example, content files may include television programs, movies, voice messages, music and other audio files, electronic mail/messages, web pages, interactive games, educational materials, software applications, etc.

Computer program code for carrying out operations of data processing systems discussed herein may be written in a high-level programming language, such as Java, AJAX (Asynchronous JavaScript), C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. Embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, apparatus, and computer program products in accordance with exemplary embodiments of the invention. These flowchart and/or block diagrams further illustrate exemplary operations for searching and navigating content files stored on a device, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

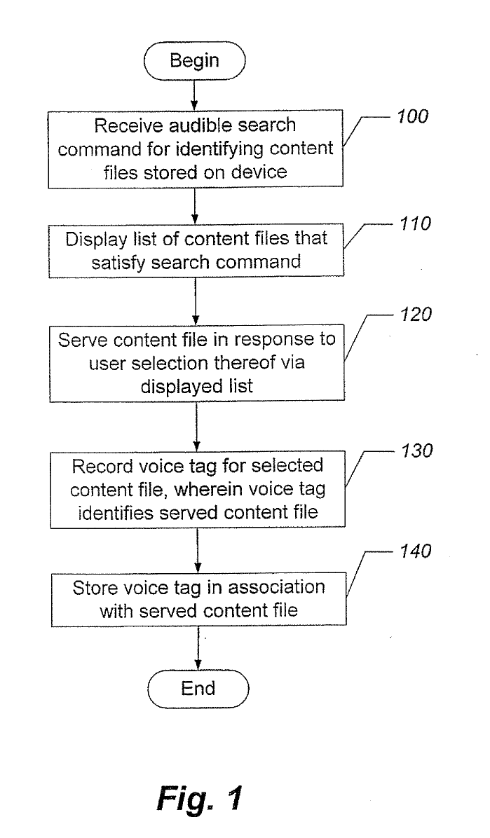

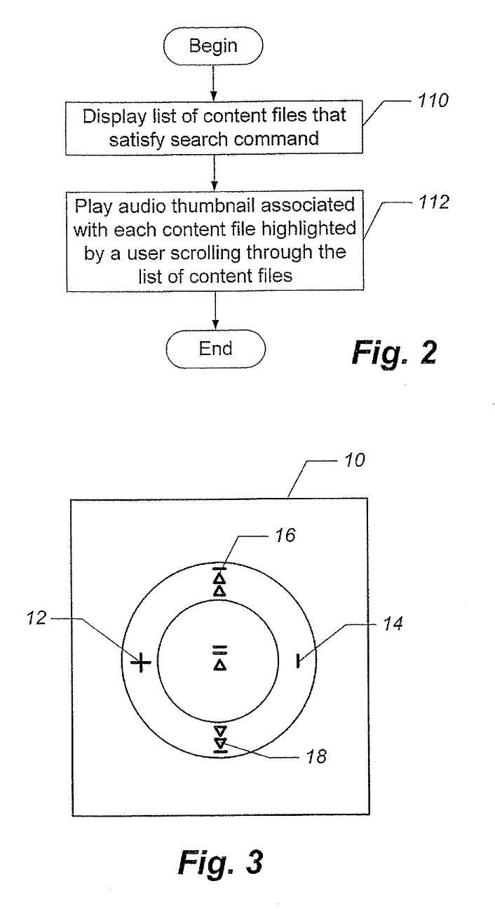

Exemplary operations for tagging, browsing and searching through content files stored on a device, will now be described with reference to FIGS. 1-2. An audible search command is received by a device having content files stored therein (Block 100). The content files may include audio files (e.g., songs, etc.), video files, text files, image files, etc. The device is configured to search the content files stored therein and display a list of content files that satisfy the audible search commands (Block 110). For example, the stored content files may be songs and the audible search command may be “Tom Petty.” The device searches for all songs on the device by Tom Petty and then displays the Tom Petty songs. The audible searching is performed by one or more voice recognition algorithms, which are well known to those skilled in the art.

The device, in response to user selection of a displayed content file, serves the content file to the user (Block 120). The term “serves” refers to any possible way that a device can play, perform, and display the contents of a file. For example, if a selected content file is an audio file (e.g., a song), serving the selected file means playing the audio file via the device (or via another device in communication therewith). If a selected content file is a video file, serving the selected file means displaying the video file via the device (or via another device in communication therewith). If a selected content file is a text file, serving the selected file means displaying the text file and/or audibly playing the text file (or via another device in communication therewith). If a selected content file is an image file, serving the selected file means displaying the image file via the device (or via another device in communication therewith).

Content files that satisfy the search criteria may be displayed visually via a display of the device and/or audibly via a speaker of the device. For example, a list of Tom Petty songs may be displayed to the user via a display and/or audibly announced to the user via the device speaker. A “displayed” content file may be selected by a user in various ways including, but not limited to, selection via a mouse, keyboard, touch screen, thumb wheel, click wheel, input pad, etc. In addition, a displayed content file may be selected via an audible command from the user.

According to some embodiments of the present invention, an audio thumbnail may be associated with each content file (and/or each group of content files) stored on a device. Each audio thumbnail is a meaningful portion of the content of a respective content file. For example, for audio files such as songs, an audio thumbnail may include one or more musical notes from the audio file. The one or more notes are selected such that the user can readily identify the audio file. As an example, a distinctive group of notes from a Rolling Stones song can readily identify the song to a user. Alternatively, or in addition thereto, one or more words from the lyrics may be selected that allow a user to readily identify the song. For other types of content files, such as video files, text files and image files, an audio thumbnail may be the title of the file.

Thumbnails are normally delivered with a content file, but can be changed or mapped according to embodiments of the present invention. For example, if a voice tag exists and no thumbnail exists for a file, the voice tag may be used as the thumbnail. The voice tag can also be selected as the thumbnail where the user prefers his/her recorded tag as the thumbnail when browsing. In this case the user who recorded “TP” as a voice tag for Tom Petty songs would hear the voice tag “TP” in lieu of an audio thumbnail and know instantly that it was referring to Tom Petty.

According to other embodiments of the present invention, an audio thumbnail can be overwritten or created as follows. A user can enter “Record Thumbnail” mode and scan a media file associated with an audio thumbnail for a portion thereof that the user wants to represent the file. For example, if a user wants to make a thumbnail for the Tom Petty song “Free Falling”, the user would move to the section of the song where the vocals have a pronounced section of the word “Free”, and mark that as the thumbnail. The user can enter the thumbnail record mode via a device's menu, or by speaking the word “THUMB” as a voice command while the media file is paused, for example.

Navigating through a plurality of content files stored on a device may include playing an audio thumbnail associated with each content file highlighted by a user scrolling through a displayed list of content files (Block 112, FIG. 2). For example, a user may scroll through a list of content files displayed via a device (Block 110) and an audio thumbnail is played for each respective content file highlighted by the user during a scrolling function. For example, a cursor, mouse pointer, or highlight implemented by a scrolling function may cause the audio thumbnail for a particular content file to be played via the device.

For devices not have a visual display, the audio thumbnails may be played in response to a user scrolling function and/or in response to a user issuing an audible scrolling command. For example, referring to FIG. 3, a device 10 that is configured to play audio files but that does not having a visual display is illustrated. Audio thumbnails associated with music files on the device 10 may play at either a manually scrolled rate by finger motion on the up or down directional controls 12, 14, or at an auto scan rate which can be increased or decreased, with forward and backward capability, for example, via controls 16, 18. A user may start the process by saying “TP” (or hearing it while browsing the artists of music files stored on the device 10) to get to the Tom Petty section using the audio search function, and then invoke the audio browse to rapidly play back the audio thumbnails associated with the Tom Petty music files so the user can select a Tom Petty song.

Each audio thumbnail is user selectable and configured to play and/or display a respective content file associated therewith via the device. For example, user selection via a mouse, keyboard stroke, touch screen, audible command, etc., causes the content file associated with the audible thumbnail to be played and/or displayed. According to some embodiments of the present invention, a voice tag may be recorded by a user for a selected content file via the device (Block 130) and stored in association with the content file (Block 140). The voice tag identifies a served content file and can be used for subsequent selection of the content file by the user. For example, after searching for Tom Petty songs stored on a device, the user can add a voice tag to a particular Tom Petty song such that this particular song can be readily and easily located in the future and without requiring a search.

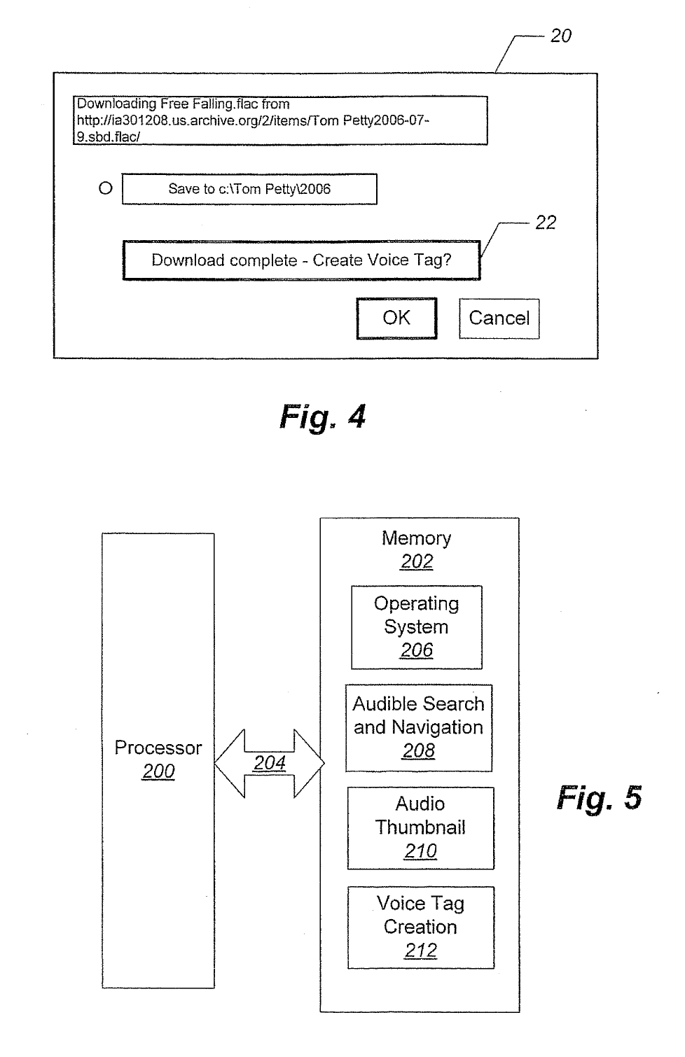

According to some embodiments of the present invention, a voice tag may be recorded when a file is downloaded to a device. For example, as illustrated in FIG. 4, a user has downloaded a music file via user interface 20. The user is being asked via box 22 whether to record a voice tag for the downloaded file. Voice tags can be recorded for individual files, folders of files, groups of folders, etc. According to some embodiments of the present invention, the voice command “TAG” (or some other voice command) could be used to cause a device to go into a mode for recording a voice tag.

According to some embodiments of the present invention, a voice tag may be associated with a group of files. For example, a voice tag may be associated with all Tom Petty songs. A user may then issue a simple audible command such as, for example, “Tom Petty” and all of the Tom Petty songs stored on the device are displayed and/or queued up for being played. Another voice tag associated with a particular Tom Petty song in the displayed (and/or queued up) list may be used to play the particular song associated therewith. For example, a voice tag that identifies the Tom Petty song “Free Falling” may be utilized to play that song. Thus, a user may issue the audible command “Free Falling” (or “Tom Petty, Free Falling”) and the song is played via the device. A voice tag may also be utilized as an audio thumbnail. According to some embodiments of the present invention, a voice tag associated with a content file may be configured to modify how a content file is played and/or displayed via the device. For example, a voice tag may include an audible command that directs the device to play an audio file faster, slower, higher in octave, etc.

According to some embodiments of the present invention, one or more playlists can be created from voice tags created by users. According to some embodiments of the present invention, one or more playlists can be created from audio thumbnails. Audio thumbnails and/or voice tags can be arranged in virtually any manner to form playlists according to embodiments of the present invention.

FIG. 3 illustrates a processor 200 and a memory 202 hosted by a device that may be used in embodiments of methods, apparatus, and computer program products for searching and navigating stored content files, according to some embodiments of the present invention. The processor 200 communicates with the memory 202 via an address/data bus 204. The processor 200 may be, for example, a commercially available or custom microprocessor. The memory 202 is representative of the overall hierarchy of memory devices containing the software and data used to execute operations for audibly searching and navigating content files as described herein, in accordance with some embodiments of the present invention. The memory 202 may include, but is not limited to, the following types of devices: cache, ROM, PROM, EPROM, EEPROM, flash, SRAM, and DRAM.

As shown in FIG. 3, the memory 202 may hold various categories of software and data: an operating system 206, audible search and navigation application 208, audio thumbnail application 210, and voice tag creation application 212. The operating system 206 controls operations of the device upon which the content files are stored. In particular, the operating system 206 may manage a device's resources and may coordinate execution of various programs (e.g., the audible search and navigation application, the audio thumbnail application, and the voice tag creation application, etc.) by the processor 200.

The audible search and navigation application 208 comprises logic for receiving and carrying out audible search and navigation commands from a user. The audible search and navigation application 208 includes voice to text conversion abilities for translating audible voice commands to text for use in searching and navigating among a plurality of content files (and/or other data describing the content files) stored on the device. The audible search and navigation application 208 is configured to display, visually (if a display exists) and/or audibly a list of content files that satisfy search and navigation commands. The audible search and navigation application 208 is also configured to serve content files in response to user selection thereof via the displayed list. For example, if a selected content file is an audio file, the audible search and navigation application 208 directs an application such as a media player to play the audio file; if a selected content file is a video file, the audible search and navigation application 208 directs an application such as a media player to play the audio file; if a selected content file is a text file, the audible search and navigation application 208 directs an application to display the text file or audibly read the text file; if a selected content file is an image file, the audible search and navigation application 208 directs an image display application to display the image file.

The audio thumbnail application 210 is configured to play an audio thumbnail associated with each content file highlighted by a user via a scrolling function of the device scrolling through a list of content files. As described above, an audio thumbnail may be one or more musical notes if a respective content file is a song. An audio thumbnail may be an audio description of a respective content file. Moreover, the audio thumbnail application 210 is configured to play and/or display a respective content file associated with an audio thumbnail when an audio thumbnail is selected. The audio thumbnail application 210 may also be configured to create and edit audio thumbnails.

The voice tag creation application 212 is configured to create voice tags and store them with respective content files.

FIGS. 1-5 illustrate the architecture, functionality, and operations of some embodiments of methods, systems, and computer program products for audibly searching and navigating content files. In this regard, each block represents a module, segment, or portion of code, which comprises one or more executable instructions for implementing the specified logical function(s). It should also be noted that in other implementations, the function(s) noted in the blocks may occur out of the order noted in FIGS. 1-2. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of searching content files stored on a device, comprising:
receiving an audible search command at the device from a user, wherein the search command includes search criteria for identifying one or more content files stored on the device;
displaying a list of one or more content files that satisfy the search command; and
serving a content file via the device in response to user selection thereof via the displayed list.

2. The method of claim 1, wherein a selected content file is an audio file and wherein serving the selected content file comprises playing the audio file via the device.

3. The method of claim 1, wherein a selected content file is a video file and wherein serving the selected content file comprises displaying the video file via the device.

4. The method of claim 1, wherein a selected content file is a text file and wherein serving the selected content file comprises displaying the text file via the device.

5. The method of claim 1, wherein a selected content file is an image file and wherein serving the selected content file comprises displaying the image file via the device.

6. The method of claim 1, wherein serving a content file comprises serving the content file via the device in response to receiving an audible selection command from the user.

7. The method of claim 1, wherein displaying a list of one or more content files that satisfy the search command comprises playing an audio thumbnail associated with each content file highlighted by a user scrolling through the list of content files, wherein each audio thumbnail is a meaningful portion of content of a respective content file.

8. The method of claim 7, wherein each audio thumbnail is user selectable and configured to play and/or display a respective content file associated therewith via the device.

9. The method of claim 7, wherein the plurality of content files are audio files and wherein each audio thumbnail comprises one or more musical notes from a respective audio file.

10. The method of claim 7, wherein the plurality of content files are selected from the group consisting of audio files, video files, text files and image files, and wherein each audio thumbnail comprises an audio description of a respective content file.

11. The method of claim 1, wherein displaying a list of one or more content files that satisfy the search command comprises playing a voice tag associated with each content file highlighted by a user scrolling through the list of content files, wherein each voice tag has been recorded by the user and identifies a respective content file.

12. A method of tagging content files stored on a device, comprising
recording a voice tag for a content file via the device, wherein the voice tag identifies the content file and can be used for subsequent selection of the content file by the user; and
storing the recorded voice tag in association with the content file.

13. The method of claim 12, wherein the voice tag contains an audio command that directs the device to modify how the content file associated with the voice tag is served to the user via the device.

14. The method of claim 12, wherein the voice tag identifies a group of content files and can be used for subsequent selection of content files within the group by the user.

15. A method of browsing content files stored on a device, comprising:
scrolling through the content files, wherein each content file has an audio thumbnail associated therewith, wherein each audio thumbnail is a meaningful portion of content of a respective content file, and wherein the audio thumbnail for each file scrolled is played via the device.

16. The method of claim 15, wherein one or more audio thumbnails are voice tags recorded by a user.

17. An apparatus, comprising:
a plurality of content files stored therein;
a user selectable audio thumbnail associated with each content file, wherein each audio thumbnail is a meaningful portion of content of a respective content file; and
a processor that is configured to serve a content file to a user in response to user selection of a respective audio thumbnail.

18. The apparatus of claim 17, wherein the processor is further configured to:
receive an audible search command from a user, wherein the search command includes search criteria for identifying one or more content files;
display a list of one or more content files that satisfy the search command; and
serve a content file in response to user selection thereof via the displayed list.

19. The apparatus of claim 17, wherein the processor is further configured to:
record a voice tag for the selected content file, wherein the voice tag identifies the served content file and can be used for subsequent selection of the content file by the user; and
store the recorded voice tag in association with the served content file.

20. The apparatus of claim 17, wherein the processor is further configured to play an audio thumbnail for each file during a scrolling operation.
